(19) United States
(12) Patent Application Publication
(10) Pub. No.: US 2026/0065005 A1
(43) Pub. Date: Mar. 5, 2026

(54) IMPLANTABLE RADIO FREQUENCY IDENTIFICATION ELECTRONIC TAG SYSTEM FOR TEMPERATURE MEASUREMENT AND MANUFACTURING METHOD THEREFOR

(71) Applicants: State Grid Jiangsu Electric Power Co., Ltd. Research Institute, Nanjing (CN); Jiangsu Electric Power Test Research Institute Co. Ltd, Nanjing (CN)

(72) Inventors: Zhaojie Chu, Nanjing (CN); Jiagui Tao, Nanjing (CN); Chenggang Li, Nanjing (CN); Yunfeng Cai, Nanjing (CN); Jianjun Liu, Nanjing (CN); Jianguo Zhang, Nanjing (CN); Danchen Mao, Nanjing (CN); Yutong Chen, Nanjing (CN); Siqi Song, Nanjing (CN); Heng Zhao, Nanjing (CN); Jianzhuo Dai, Nanjing (CN); Jinwei Zhu, Nanjing (CN)

(21) Appl. No.: 19/317,003

(22) Filed: Sep. 2, 2025

(30) Foreign Application Priority Data
Sep. 3, 2024 (CN) 202411229473.9

(51) Int. Cl. G06K 19/07; G01K 1/024; G06K 1/12

(52) U.S. Cl. CPC G06K 19/0717; G01K 1/024; G06K 1/12

(57) ABSTRACT

An implantable radio frequency identification (RFID) electronic tag system for temperature measurement includes an electronic tag, which includes a radio frequency (RF) chip, an antenna, a tag substrate, and a reflector. The antenna and the reflector are located on upper and lower surfaces of the tag substrate, respectively. The tag substrate has a through hole, and the RF chip and the antenna are arranged inside the through hole. The RF chip is electrically connected to the antenna and is configured to detect temperature and incorporate a pre-programmed tag encoding. According to the present disclosure, by implanting the electronic tag into a cable, precise traceability and comprehensive management of the cable may be achieved, along with accurate in-cable temperature measurement.

### CROSS-REFERENCE TO RELATED APPLICATION

This application claims priority of Chinese Patent Application No. 202411229473.9, filed on Sep. 3, 2024, the entire contents of which are incorporated herein by reference.

### TECHNICAL FIELD

The present disclosure belongs to the technical field of implantable electronic tags, and specifically to an implantable radio frequency identification (RFID) electronic tag system for temperature measurement and a manufacturing method therefor.

### BACKGROUND

The development of modern intelligent supply chain systems presents evolving and more demanding requirements for the construction and application of material traceability and a unified identity code (referred to as physical “identity document, ID”) for physical assets. A physical “ID” Internet of Things (IoT) tag serves as a critical medium and information carrier for the ubiquitous connectivity of power grid materials. It plays a significant role in the development of modern intelligent supply chains. In the future, integrated with blockchain technology, it can provide reliable assurance for data transmission and interaction related to the physical “ID” for electric power materials, thereby addressing challenges such as secure storage and sharing of physical “ID” IoT tag data and cross-entity trust issues, while laying the foundation for future business expansions like supply chain finance.

Currently, the implementation of physical “ID” in cable operation and maintenance management is being piloted by affixing RFID electronic tags to exteriors of cables. For example, as disclosed in patent CN108197689A titled “A Passive RFID Cable Temperature Measurement Tag,” temperature data from the passive RFID cable temperature measurement tag can be read and identified by an external reader device. The passive RFID cable temperature measurement tag includes: a metal clamp strap, an antenna, and a flexible printed circuit (FPC) board. The metal clamp strap is mounted on the cable and is configured to conduct heat from the cable. The antenna is located on the metal clamp strap. It is configured to transmit radio frequency (RF) signals between the passive RFID cable temperature measurement tag and the external reader device, and is also configured to conduct heat from the cable. The FPC board is located above the antenna and includes a passive underfloor heating (UFH) temperature tag chip. The FPC board is configured to couple with the RF signals transmitted by the antenna and conduct heat from the cable, thereby achieving the detection of the cable's temperature by the passive UFH temperature tag chip. However, with the rapid advancement of urban development, the management of distribution network cable supply chains has revealed the following shortcomings in practical implementation:

(1) High cost of on-site coding: the on-site coding of RFID tags for distribution cables involves secondary code issuance and binding, consuming significant human and material resources. Moreover, continuous power grid construction projects lead to a constant influx of incremental assets into the network, making the coding and labeling of assets exceedingly challenging. Simultaneously, on-site coding for existing equipment fails to effectively support business processes such as production monitoring, logistics distribution, and warehouse management, resulting in the need for additional on-site coding operations specifically dedicated to material identification.

(2) Difficulties in cable asset inventory: due to length management characteristics of cable materials, segment-based inventory, remaining material tracking, and material withdrawal primarily rely on manual reading of remaining meter markings on-site. This process is highly susceptible to weather conditions, personnel status, and cable sheath wear, resulting in unreliable inventory accuracy and low efficiency.

(3) Difficult traceability of equipment withdrawal: once cables are withdrawn from inventory, it becomes challenging to effectively monitor the actual quantities used by construction units or verify the types of cables deployed, creating risks such as material substitution (e.g., replacing high-grade with low-grade materials) or theft through unauthorized shortening of cable lengths. To fundamentally solve this problem, it is necessary to establish a “real-time, secure information channel” that transparently transmits original procurement and material withdrawal data to a construction site, supervision units, and audit units through technical means.

(4) Difficult implementation of coding for incremental assets: currently, RFID electronic tags applied in the field of cables are primarily externally attached to cable bodies. If factory coding for incremental equipment is adopted, issues such as tags being knocked off or detached during storage and transfer, or straps/adhesives loosening due to environmental exposure and prolonged use may arise. This approach cannot adequately support the need for unified equipment coding and full lifecycle management.

(5) Deficiencies in last-mile material management: power construction projects are susceptible to frequent material handling, dispersed construction sites, and extended project durations due to various influencing factors. Construction units often store bulk materials at mobile or temporary storage points before allocating the materials to daily construction sites based on project progress. This practice leads to gaps in last-mile material management, making it difficult to promptly identify and locate required cable equipment and precise positions. Consequently, it increases the likelihood of material loss or theft.

(6) Limitations in temperature measurement targets: due to its setting mode, the electronic tag can only measure the temperature of an outer surface/layer of the cable. However, in practical cable temperature measurement scenarios, there is often a need to measure the internal temperature of the cable conductor. Existing RFID electronic tags can no longer meet this requirement.

Therefore, there is a pressing need in this field for an implantable electronic tag that enables in-cable temperature measurement.

### SUMMARY

In response to the above defects in the related art, the present disclosure provides an implantable RFID electronic tag system for temperature measurement and a manufacturing method therefor. By implanting an electronic tag into a cable, precise traceability and comprehensive management of the cable can be achieved, along with accurate in-cable temperature detection.

In a first aspect, the present disclosure provides an implantable RFID electronic tag system for temperature measurement, including an electronic tag, the electronic tag including an RF chip, an antenna, a tag substrate, and a reflector;
the antenna and the reflector being located on upper and lower surfaces of the tag substrate, respectively; the tag substrate having a through hole, and the RF chip and the antenna being arranged inside the through hole; and the RF chip being electrically connected to the antenna, and configured to detect temperature and incorporate a pre-programmed tag encoding; and
a manufacturing module, configured to program encoding information and issuance information into the RF chip; the encoding information including the tag encoding; and the issuance information including a unique identifier and a temperature sensing strategy for detecting internal temperature of the cable.

In a further description, the antenna is formed by folding a metal sheet into a hollow box-shaped structure, and the box-shaped structure includes an upper sheet and a lower sheet, and a mounting pad is arranged inside the box-shaped structure to secure the RF chip.

In a further description, the RF chip is electrically connected to one side of the lower sheet through an impedance matching tuning loop, with the other side of the lower sheet being connected to the upper sheet.

In a further description, one end of the impedance matching tuning loop, which is connected to the RF chip, has a feed port for impedance matching with the antenna.

In a further description, the antenna includes a rectangular metal patch, a ground plane, a shorting metal plate, a feed line, and a dielectric substrate; the ground plane is fixed to one side of the dielectric substrate, and the rectangular metal patch and the shorting metal plate are fixed to the other side; and the feed line is connected to the shorting metal plate, and two ends of the shorting metal plate are connected to the rectangular metal patch and the ground plane, respectively.

In a further description, the RF chip includes a temperature sensor circuit for temperature detection; the temperature sensor circuit includes an analog front-end (AFE) circuit and an analog-to-digital converter (ADC) circuit connected to the AFE circuit; and the AFE circuit is configured to output a voltage and a voltage difference to the ADC circuit using two transistors with different bias currents, and the ADC circuit is configured to determine the detected temperature result based on the voltage and the voltage difference.

In a further description, the RF chip incorporates the pre-programmed tag encoding; the tag encoding contains implantation information of the electronic tag and production information of a cable; and the implantation information includes serial information, and the production information includes manufacturer information, batch information, and cable serial number information; and
the tag encoding is specifically represented as:

$$T E = [ ( m i , bi , cr , si , cc ) \vert m i ∈ M , bi ∈ B , cr ∈ CR , si ∈ S ]$$

$$m i = {\sum }_{j = 1}^{k} {D}_{j} ( d ) * {10}^{j - 1}$$

where TE is a dataset of the tag encoding, M is a data encoding subset for manufacturer information, B is a data encoding subset for batch information, CR is a data encoding subset for cable serial number information, and S is a data encoding subset for serial information; cc is a check code, mi is a data field for manufacturer information, bi is a data field for batch information, cr is a data field for cable serial number information, and si is a data field for serial information; and d is the manufacturer information, Dⱼ(d) is an American standard code for information interchange (ASCII) code corresponding to a jth symbol of the manufacturer information, and k is the number of symbols in the manufacturer information.

In a further description, the system further includes the manufacturing module electrically connected to the electronic tag, and the manufacturing module is configured to program encoding information and issuance information into the RF chip; the encoding information includes the tag encoding; and the issuance information includes a unique identifier and a temperature sensing strategy for detecting internal temperature of the cable; and
the manufacturing module, configured to program encoding information and issuance information into the RF chip, includes the steps of:
generating the tag encoding based on the implantation information of the electronic tag and the production information of the cable, and writing the tag encoding into the RF chip;
providing the temperature sensing strategy based on cable parameters at an implantation position of the electronic tag and detected temperature parameters, combined with ambient temperature parameters of the cable's position; and
generating the unique identifier based on electronic tag parameters and parameters of a reader matching the electronic tag, and uploading the unique identifier and the temperature sensing strategy for storage.

In a further description, the cable includes, from interior to exterior, a plurality of cable conductors, an insulation layer, a metallic shield layer, a filling layer, an armor layer, and an outer sheath, and the electronic tag is implanted between the armor layer and the outer sheath; and
the temperature sensing strategy satisfies the following relationship:

$${θ}_{c} = {θ}_{0} - 2 {θ}_{p} + ( {W}_{c} + 0.5 {W}_{d} ) {A}_{1} {T}_{1} - 3 [ {W}_{d} + ( 1 + {λ}_{1} ) {W}_{c} ] {A}_{2} {T}_{2} + 3 [ {W}_{d} + ( 1 + {λ}_{1} + {λ}_{2} ) {W}_{c} ] ( {A}_{3} {T}_{3} + {A}_{4} {T}_{4} )$$

where θ_{c} is a cable conductor temperature, θ₀ is an ambient temperature at the cable's position, θₚ is a temperature detected by the electronic tag, W_{c} is a cable conductor loss, W_{d} is a dielectric loss of the insulation layer, T₁ is a thermal resistance of the insulation layer, T₂ is a thermal resistance of the filling layer, T₃ is a thermal resistance of the outer sheath, T₄ is a thermal resistance of a surrounding medium, λ₁ is a resistive loss factor of the metallic shield layer, λ₂ is a resistive loss factor of the armor layer, and A₁, A₂, A₃, and A₄ are all correction coefficients.

In a further description, the reader parameters include reader power and frequency, and the electronic tag parameters include data length and key type of the electronic tag.

In a further description, writing the unique identifier into the RF chip and uploading the identifier for storage includes the steps of:
validating the tag encoding of the electronic tag, and verifying the electronic tag parameters and reader parameters stored in the RF chip against the unique identifier; and
writing the unique identifier that has passed validation of the tag encoding, the electronic tag parameters, and the reader parameters into the RF chip, and uploading the identifier for storage.

In a second aspect, the present disclosure provides a manufacturing method for an implantable RFID electronic tag for temperature measurement, adopting the above implantable RFID electronic tag system for temperature measurement, including the steps of:
assembling an RF chip, an antenna, a tag substrate, and a reflector into an electronic tag;
and programming encoding information and issuance information into the RF chip.

The implantable RFID electronic tag system for temperature measurement and the manufacturing method provided by the present disclosure have at least the following advantages.

(1) By implanting the electronic tag into the cable and programming the issuance information, precise traceability and comprehensive management of the cable can be achieved. Meanwhile, through the configured temperature sensing strategy, accurate in-cable temperature detection can be achieved, thereby expanding the applicable scenarios of the electronic tag.

(2) By reading the electronic tag on the cable, cable information can be obtained, which can coordinate identification code requirements from various stakeholders including manufacturing units, material management departments, and field maintenance personnel, addressing critical operational challenges in cable material management such as product substitution, false reporting of usage quantities, and residual material inventory inaccuracies. Consequently, it significantly enhances the accuracy of equipment monitoring and contract performance tracking, thereby ensuring a stable and orderly supply of power grid materials.

(3) By performing computational analysis on readily detectable ambient temperature and cable armor layer temperature, an internal temperature of the target cable conductor can be precisely determined, reliably meeting the requirement for obtaining cable conductor temperature in practical applications.

### BRIEF DESCRIPTION OF THE DRAWINGS

FIG. 1 is a schematic diagram of an implantable RFID electronic tag system for temperature measurement according to the present disclosure;

FIG. 2 is another structural schematic diagram of an RFID electronic tag system according to an embodiment of the present disclosure;

FIG. 3 is a schematic structural diagram of an electronic tag according to an embodiment of the present disclosure;

FIG. 4 is a circuit schematic diagram of a T-matching network according to an embodiment of the present disclosure;

FIG. 5 is a circuit schematic diagram of an antenna according to an embodiment of the present disclosure;

FIG. 6 is a circuit schematic diagram of a temperature sensor circuit according to an embodiment of the present disclosure;

FIG. 7 is a schematic structural diagram of a cable according to an embodiment of the present disclosure; and

FIG. 8 is a flowchart of a manufacturing method for an implantable RFID electronic tag for temperature measurement according to the present disclosure.

Reference numerals and denotations thereof: 11—RF chip; 12—antenna; 121—rectangular metal patch; 122—ground plane; 123—shorting metal plate; 124—dielectric substrate; 13—tag substrate; 14—reflector; 21—cable conductor; 22—insulation layer; 23—metallic shield layer; 24—filling layer; 25—armor layer; and 26—outer sheath.

### DETAILED DESCRIPTION

To facilitate a better understanding of the above technical solutions, the technical solutions are illustrated in detail with reference to the accompanying drawings of the specification and specific implementations. Obviously, the embodiments described are only some, rather than all embodiments of the present disclosure. Based on the embodiments of the present disclosure, all other embodiments obtained by those ordinary skilled in the art without creative efforts fall within the scope of protection of the present disclosure.

The terms used in the embodiments of the present disclosure are used solely for describing specific implementations and are not intended to limit the present disclosure. The singular forms “an,” “the,” and “this” used in the embodiments of the present disclosure and the appended claims are intended to include plural forms as well, unless the context clearly indicates otherwise. The term “a plurality” generally includes at least two.

It is to be noted that the terms “include”, “contain”, or any variants thereof are intended to cover a non-exclusive inclusion. Thus, a product or device with a series of elements not only includes those elements, but may also include other elements not explicitly listed, or elements that are inherent to such product or device. Without additional limitations, an element defined by the statement “including a . . . ” does not preclude the existence of additional identical elements in a product or device including that element.

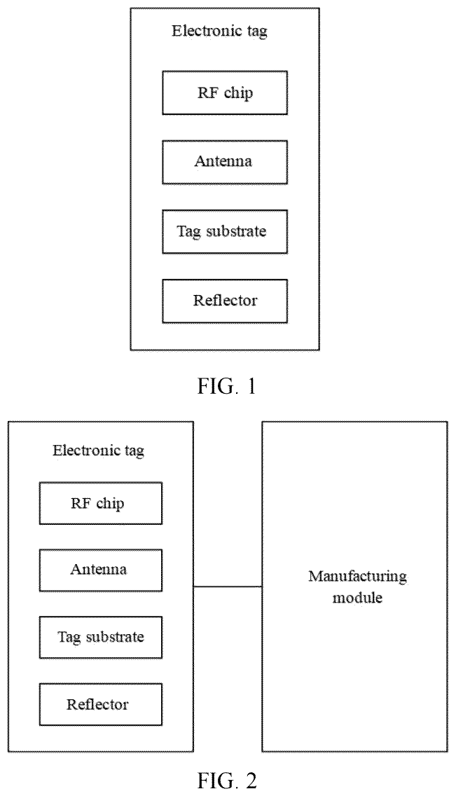

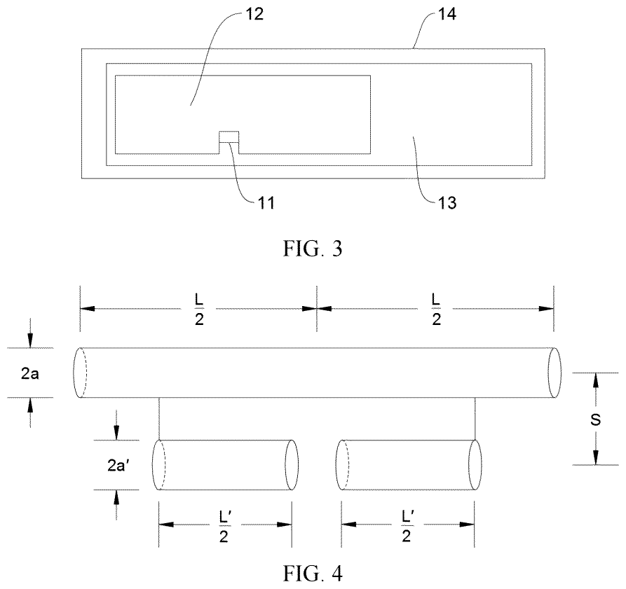

Referring to FIGS. 1-3, the present disclosure provides an implantable RFID electronic tag system for temperature measurement, including an electronic tag and a manufacturing module electrically connected to the electronic tag. The electronic tag includes an RF chip, an antenna, a tag substrate, and a reflector.

The antenna and the reflector are located on upper and lower surfaces of the tag substrate, respectively; the tag substrate has a through hole, and the RF chip and the antenna are arranged inside the through hole; and the RF chip is electrically connected to the antenna and configured to detect temperature and incorporate a pre-programmed tag encoding.

The manufacturing module is configured to program encoding information and issuance information into the RF chip, in which the encoding information includes the tag encoding, and the issuance information includes a unique identifier and a temperature sensing strategy for detecting an internal temperature of a cable.

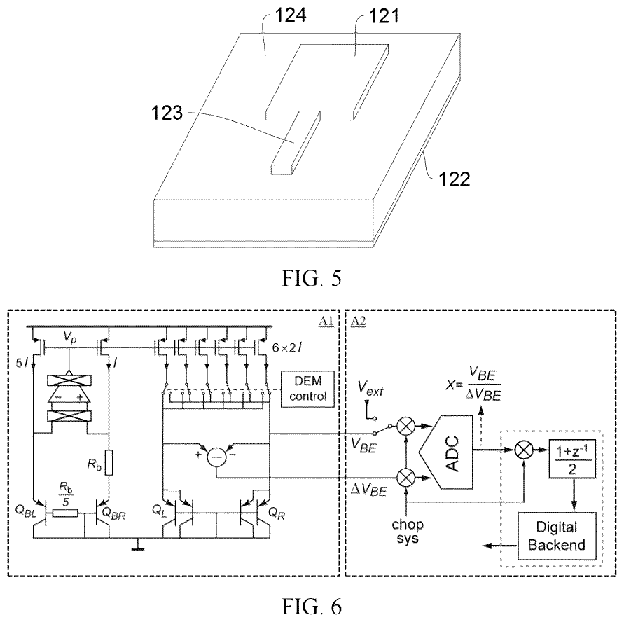

In practical application scenarios, the antenna is formed by folding a metal sheet into a hollow box-shaped structure, and the box-shaped structure includes an upper sheet and a lower sheet, and a mounting pad is arranged inside the box-shaped structure to secure the RF chip. The RF chip is electrically connected to one side of the lower sheet through an impedance matching tuning loop, with the other side of the lower sheet being connected to the upper sheet. One end of the impedance matching tuning loop, which is connected to the RF chip, has a feed port for impedance matching with the antenna. The mounting pad is made of silicone material with a thickness of 1 mm. The impedance matching tuning loop may be implemented as a T-matching network. As shown in FIG. 4, the T-matching network is configured to connect two dipole antennas through a microstrip transmission line. The larger dipole antenna has a length L and a radius a, while the other dipole has a length L′ (where L′≠L) and a radius a′ (where a′≠a). These two dipoles form a non-balanced parallel transmission line with a center-to-center separation distance between conductors being s. Due to the relatively short length of the dipoles in the T-matching network, which are selected in a range of 0.03λ-0.06λ, the antenna impedance exhibits a complex form with inductive characteristics. Since the antenna of the electronic tag needs to exhibit inductive impedance, the T-matching network can be applied to the antenna of the electronic tag. By appropriately adjusting parameters of the T-matching network, the required impedance can be achieved, thereby obtaining an optimal impedance bandwidth. Additionally, referring to FIG. 5, the antenna may also be configured as a planar inverted F-shaped antenna (PIFA), formed by a microstrip antenna short-circuited at one end. Its structure includes a planar rectangular metal patch, a large ground plane, a narrow shorting metal plate, a dielectric substrate, and a feedline (not shown). The ground plane is fixed to one side of the dielectric substrate, the rectangular metal patch and the shorting metal plate are fixed to the other side, the feed line is connected to the shorting metal plate, and two ends of the shorting metal plate are connected to the rectangular metal patch and the ground plane, respectively. One end of the antenna is short-circuited, which can greatly reduce the size of the antenna. The ground plane within the antenna serves to isolate metallic surface effects. When placed on a surface of an armor layer of the cable, the metallic characteristics of the armor layer have minimal impact on antenna matching and bandwidth, thereby exhibiting metal-resistant properties. When the antenna of the electronic tag is placed in free space (non-metallic surface), it exhibits a half-power bandwidth of 15 MHz within a frequency range of 910 MHz-920 MHz, and a maximum read distance of 2.8 meters. When the tag is placed on the metal surface of the armor layer, it demonstrates a half-power bandwidth of 15 MHz within a frequency range of 910 MHz-925 MHz, and a maximum read distance of 3 meters. It can be observed that the tag exhibits no performance degradation when placed on the metallic surface, due to the inherent ground plane design in the antenna structure, which provides effective metal-resistant functionality. Furthermore, when placed on the metallic surface, electromagnetic waves are reflected from the metal surface, enhancing the directivity of the antenna of the electronic tag, increasing its gain, and extending the identification range of the electronic tag.

In this embodiment, an electronic chip is configured to detect temperature through a temperature sensor circuit. Specifically, referring to FIG. 6, the RF chip may include the temperature sensor circuit for temperature detection. The temperature sensor circuit includes an AFE circuit (as shown in FIG. 6, A1) and an ADC circuit connected to the AFE circuit (as shown in FIG. 6, A2). The AFE circuit is configured to output a voltage and a voltage difference to the ADC circuit using two transistors with different bias currents, and the ADC circuit is configured to determine the detected temperature result based on the voltage and the voltage difference. In practical application scenarios, a voltage ΔV_{BE}, which is a difference between base-emitter voltages V_{BE} of the two transistors with different bias currents in the AFE circuit, exhibits a proportional to absolute temperature (PTAT) characteristic. By quantifying the value of the ΔV_{BE}, the ambient temperature can be accurately determined. During quantization of the ΔV_{BE}, a temperature-independent reference voltage VREF is required. This is typically achieved by summing a negative temperature coefficient V_{BE} with αΔV_{BE}, thereby obtaining a zero temperature coefficient reference voltage V_{REF}. In this way, a ratio of V_{BE} to V_{REF} will contain temperature-dependent information. To fully utilize a full-scale range of the ADC circuit, using αΔV_{BE} as a quantization target can achieve optimal utilization of the ADC circuit. In the ADC circuit, the architecture and resolution of the ADC need to be determined. Specifically, an output of the ADC circuit can be configured as follows:

$$Dout = A \frac{α}{X + α} + B = A μ + B$$

$$X = \frac{{V}_{BE}}{Δ {V}_{BE}}$$

where a value of X exhibits a nonlinear dependence on temperature. Through algorithmic processing of the X value with appropriately selected calibration parameters (α, A, and B) in the algorithm, high linearity can be achieved within a suitable range, resulting in an optimal temperature-dependent curve (linear curve). For example, α=13, A≈600, B≈283.

For the ADC, successive approximation register (SAR) ADC and sigma-delta (ΣΔ) ADC are adopted based on considerations of performance, power consumption, area, and accuracy. Specifically, the SAR ADC is designed as a 5-bit converter, while the ΣΔ ADC is implemented as an 8-bit converter. The ADC circuit further includes a cascaded integrator-comb (CIC) digital filter. Specifically, the most significant bits MSB<4: 0> in ADC_DATA<12: 0> correspond to a decimal value from the SAR ADC, while the least significant bits LSB<8:0> are obtained from a decimation filter. The complete output ADC_DATA<12:0> is derived as follows: X=n+2μ, where X is a decimal value of ADC_DATA<12:0>, n is a decimal value from the SAR ADC, μ is a fractional remainder from the ΣΔ ADC after CIC decimation (obtained by converting the lowest 8 bits to decimal and dividing by the decimal value represented by 8′b11111111, resulting in 0<μ<1). The temperature is calculated using calibration parameters.

In this embodiment, to achieve cross-disciplinary and cross-departmental secure traceability of cable information, the tag encoding of the RF chip is designed to better adapt to the traceability management throughout the entire lifecycle of cable products. Specifically, the RF chip incorporates the pre-programmed tag encoding. The tag encoding contains implantation information of the electronic tag and production information of the cable. The implantation information includes serial information, and the production information includes manufacturer information, batch information, and cable serial number information.

The tag encoding is specifically represented as:

$$TE = [ ( mi , bi , cr , si , cc ) \vert mi ∈ M , bi ∈ B , cr ∈ CR , si ∈ S ]$$

$$mi = {\sum }_{j = 1}^{k} {D}_{j} ( d ) * {10}^{j - 1}$$

where TE is a dataset of the tag encoding, M is a data encoding subset for manufacturer information, B is a data encoding subset for batch information, CR is a data encoding subset for cable serial number information, and S is a data encoding subset for serial information; cc is a check code, mi is a data field for manufacturer information, bi is a data field for batch information, cr is a data field for cable serial number information, and si is a data field for serial information; and d is the manufacturer information, Dⱼ(d) is an ASCII code corresponding to a jth symbol of the manufacturer information, and k is the number of symbols in the manufacturer information. The check code is generated by processing other data fields within the tag encoding, excluding itself. Specific generation methods may include parity bits, cyclic redundancy check (CRC), hash functions, error correction codes, Base64 encoding, and random number generation, among others. Since the ASCII code maps each character to a specific number, it facilitates data storage and transmission. Consequently, when converting the manufacturer information into the data field, ASCII simplification can help streamline the data structure, thereby reducing the performance requirements for the RF chip in the electronic tag. Additionally, since the ASCII code can be applied across various systems with excellent compatibility, it ensures that the tag encoding in this embodiment can be adapted to electronic tags with different parameter specifications.

Furthermore, to enhance the functional characteristics of the tag encoding, the encoded content may be extended. For instance, the tag encoding may additionally include data fields for cable type information, cable model information, and cable voltage level information. This is specifically represented as:

$$TE = [ ( mi , to , mo , vl , bi , cr , si , cc ) \vert mi ∈ M , to ∈ T , mo ∈ O , vl ∈ V , bi ∈ B , cr ∈ CR , si ∈ S ]$$

$$mi = {\sum }_{j = 1}^{k} {D}_{j} ( d ) * {10}^{j - 1}$$

where TE is a dataset of the tag encoding, T is a data encoding subset for cable type information, O is a data encoding subset for cable model information, V is a data encoding subset for cable voltage level information, M is a data encoding subset for manufacturer information, B is a data encoding subset for batch information, CR is a data encoding subset for cable serial number information, and S is a data encoding subset for serial information; cc is a check code, mi is a data field for manufacturer information, to is a data field for cable type information, mo is a data field for cable model information, vl is a data field for cable voltage level information, bi is a data field for batch information, cr is a data field for cable serial number information, and si is a data field for serial information; the serial information is associated with an implantation interval of the electronic tags, and adjacent electronic tags are implanted into the cable at predetermined intervals, with serial information data of the adjacent electronic tags encoded as consecutive numerical values; and d is the manufacturer information, Dⱼ(d) is an ASCII code corresponding to a jth symbol of the manufacturer information, and k is the number of symbols in the manufacturer information. The data fields for cable type information, cable model information, and cable voltage level information may be assigned during production or warehouse entry, or alternatively derived through computational methods based on specific information through other encoding methods. For example, encoding may be implemented using ASCII encoding, Unicode encoding, Base64 encoding, URL encoding, or similar schemes.

The tag encoding of the electronic tag is configured into the RF chip through the manufacturing module, achieving the reading and verification of the tag encoding when ultimately accessed by a read/write device. Additionally, in this embodiment, besides configuring the tag encoding, the temperature sensing strategy also needs to be configured. Specifically, the manufacturing module being configured to program encoding information and issuance information into the RF chip includes the steps that:
the tag encoding is generated based on the implantation information of the electronic tag and the production information of the cable, and the tag encoding is written into the RF chip, in which the production information of the cable may also include cable type specifications, cable model information, and cable voltage level information;
the temperature sensing strategy is provided based on cable parameters at an implantation position of the electronic tag and detected temperature parameters, combined with ambient temperature parameters of the cable's position; and
the unique identifier is generated based on electronic tag parameters and parameters of a reader matching the electronic tag, and the unique identifier and the temperature sensing strategy are uploaded for storage. The unique identifier and the temperature sensing strategy can also be stored on the RF chip when it meets the storage requirements.

In this embodiment, the temperature sensing strategy is primarily designed according to the overall structure of the cable, ultimately achieving precise calculation of the cable conductor temperature. Specifically, referring to FIG. 7, the cable includes, from interior to exterior, a plurality of cable conductors, an insulation layer, a metallic shield layer, a filling layer, an armor layer, and an outer sheath, and the electronic tag is implanted between the armor layer and the outer sheath. The assembly formed by the cable conductor, the insulation layer, and the metallic shield layer may be configured in corresponding quantities according to different requirements, preferably in sets of three. Correspondingly, the temperature sensing strategy satisfies the following relation:

$${θ}_{c} = {θ}_{0} - 2 {θ}_{p} + ( {W}_{c} + 0.5 {W}_{d} ) {A}_{1} {T}_{1} - 3 [ {W}_{d} + ( 1 + {λ}_{1} ) {W}_{c} ] {A}_{2} {T}_{2} + 3 [ {W}_{d} + ( 1 + {λ}_{1} + {λ}_{2} ) {W}_{c} ] ( {A}_{3} {T}_{3} + {A}_{4} {T}_{4} )$$

where θ_{c} is a cable conductor temperature, θ₀ is an ambient temperature at the cable's position, θₚ is a temperature detected by the electronic tag, W_{c} is a cable conductor loss, W_{d} is a dielectric loss of the insulation layer, T₁ is a thermal resistance of the insulation layer, T₂ is a thermal resistance of the filling layer, T₃ is a thermal resistance of the outer sheath, T₄ is a thermal resistance of a surrounding medium, λ₁ is a resistive loss factor of the metallic shield layer, λ₂ is a resistive loss factor of the armor layer, and A₁, A₂, A₃, and A₄ are all correction coefficients. The correction coefficients may be empirical values or obtained through experimentation. Specifically, the values of A₁, A₂, A₃, and A₄ fall within the range of [0.8, 1.2]. Additionally, the cable in this embodiment may further include a conductor shield layer arranged between the cable conductor and the insulation layer, as well as an inner sheath arranged between the filling layer and the armor layer.

For thermal resistance parameters in the temperature sensing strategy, the parameters can be pre-calculated by incorporating test or simulation data, based on dimensional parameters and correlation coefficients of the cable conductor, insulation layer, metallic shield layer, armor layer, and outer sheath, as well as the ambient temperature parameters and associated coefficients. As shown in the structure in FIGS. 2, T₁, T₂, T₃, and T₄ are calculated as follows:
regarding the thermal resistance of the insulation layer in the temperature sensing strategy, it satisfies the following relationship:

$${T}_{1} = \frac{{ρ}_{T}}{2 π} ln ( 1 + \frac{2 {t}_{1}}{{D}_{c}} )$$

where ρ_{T} is a thermal resistivity coefficient of the insulation layer in K·m/W, t₁ is a thickness of the insulation layer in mm, and D_{c} is a diameter of the cable conductor in mm. Specifically, the thermal resistivity coefficient of the insulation layer is 3.5 K·m/W, the thickness of the insulation layer is 6-7 mm (preferably 6.4 mm), and the diameter of the cable conductor is 22-22.5 mm (preferably 22.2 mm).

The thermal resistance of the filling layer satisfies the following relationship:

$${T}_{2} = \frac{{ρ}_{2}}{6 π} G$$

where ρ₂ is a thermal resistivity coefficient of the filling layer in K·m/W, specifically 5 K·m/W. G represents a geometric factor, which can be obtained from lookup tables depending on the cable structure.

The thermal resistance of the outer sheath satisfies the following relationship:

$${T}_{3} = \frac{{ρ}_{T}}{2 π} ln ( 1 + \frac{2 {t}_{3}}{{D}_{a}} )$$

where t₃ is a thickness of the outer sheath in mm, and D_{α} is an outer diameter of the armor layer in mm.

The thermal resistance of the ambient environment medium is selected based on the cable laying scenario. For example, when the cable is laid in the air, the thermal resistance of the ambient environment medium satisfies the following relationship:

$${T}_{4} = \frac{1}{π \cdot {D}_{e} \cdot h \cdot {( Δ {θ}_{s} )}^{\frac{1}{4}}}$$

where h is a heat dissipation coefficient, preferably h=3.5; Dₑ is an outer diameter of the cable; Δθₛ is a temperature rise of a cable surface above the ambient environment.

For loss parameters in the temperature sensing strategy, the parameters can be pre-calculated by incorporating test or simulation data, based on the dimensional parameters and correlation coefficients of the cable conductor and the insulation layer. Specifically, W_{c}, W_{d} are calculated as follows:

when calculating the cable conductor loss, the loss for a single cable conductor satisfies the following relationship:

$${W}_{c} = {I}^{2} {R}_{c}$$

where I is a current-carrying capacity of the cable conductor in A; and R_{c} is an alternating current (AC) resistance of the cable conductor in Ω.

The AC resistance per unit length of the cable conductor (Ω/m) is:

$$R = {R}_{d} ( 1 + {Y}_{1} + {Y}_{2} )$$

$${R}_{d} = {R}_{0} [ 1 + {α}_{20} ( {θ}_{c} - 20 ) ]$$

$${Y}_{1} = \frac{{X}_{s}^{4}}{192 + 0.8 {X}_{s}^{4}}$$

$${Y}_{2} = \frac{{x}_{p}^{4}}{192 + 0.8 {x}_{p}^{4}} {( \frac{{D}_{c}}{s} )}^{2} \times [ 0.312 {( \frac{{D}_{c}}{s} )}^{2} + \frac{1.18}{\frac{{x}_{p}^{4}}{192 + 0.8 {x}_{p}^{4}} + 0.27} ]$$

$${X}_{s}^{2} = \frac{8 π f}{{R}_{d}} \times 1 {0}^{- 7} {k}_{s} , {x}_{p}^{2} = \frac{8 π f}{{R}_{d}} \times 1 {0}^{- 7} {k}_{p}$$

where Rₐ is a direct current (DC) resistance per unit length of the cable conductor, in Ω/m; Y₁ is a skin effect factor; Y₂ is a proximity effect factor, R₀ is a DC resistance per unit length of the cable conductor at 20° C., in Ω/m; α₂₀ is a resistance temperature coefficient of the conductor at 20° C.; θ_{c} is a conductor temperature, in ° C., and its value depends on the type of insulating material used, with cross-linked polyethylene (XLPE) having a long-term maximum operating temperature of 90° C.; D_{c} is a diameter of the cable conductor, in mm; f is a power frequency in Hz; s is a center-to-center spacing between adjacent cable conductors, in mm; and kₛ and kₚ are constants. For compact circular stranded copper conductors, kₛ=1 and kₚ=0.8.

When calculating a dielectric loss of the insulation layer, the insulation loss within the dielectric medium is determined by applying a voltage to a cable line. Specifically, the dielectric loss per unit length per phase satisfies the following relationship:

$${W}_{d} = 2 π \cdot {f}_{1} \cdot c \cdot {U}_{0}^{2} \cdot tan δ$$

where f₁ is a line frequency in Hz; U₀ is a rated voltage for the cable in V, tan δ is a dielectric loss factor, and c is a capacitance per unit length of the cable in F/m, which satisfies the following relationship:

$$c = \frac{2 πε {ε}_{0}}{ln ( \frac{{D}_{i}}{{D}_{c}} )}$$

where ε is a relative permittivity of the insulating material; ε₀ is an absolute permittivity, preferably ε₀=8.86×10⁻¹² F/m; Dᵢ is a diameter of the insulation layer in mm; and D_{c} is a diameter of the conductor in mm.

For loss factor parameters in the temperature sensing strategy, the parameters can be pre-calculated by incorporating test or simulation data, based on the dimensional parameters and correlation coefficients of the cable conductor, the metallic shield layer, and the armor layer. λ1, λ2 are calculated as follows:

A three-core cable is wrapped with the metallic shield layer outside the insulation layer. When operating with AC, an induced voltage is generated. A portion of the magnetic flux produced by the conductor circuit interlinks with the metallic shield layer, creating an induced electromotive force (EMF) in the metallic shield layer, which causes eddy current losses. To prevent the induced EMF from endangering the safe operation of the cable, the metallic shield layer is often grounded. However, this forms a current loop, resulting in circulating current losses. Therefore, the losses in the metallic shield layer primarily include circulating current losses and eddy current losses, which satisfy the following relationship:

$${λ}_{1} = {λ}_{1}^{′} + {λ}_{1}^{″}$$

where λ₁ is a ratio of total losses in the metallic shield layer to the cable conductor losses, i.e., a resistive loss factor of the metallic shield layer;

$${λ}_{1}^{′}$$

is a ratio of the circulating current losses in the metallic shield layer to the cable conductor losses; and

$${λ}_{1}^{″}$$

is a ratio of the eddy current losses in the metallic shield layer to the cable conductor losses.

When the center-to-center spacing s between two cable conductors significantly exceeds the diameter Dₛ of the metallic shield layer, the induced electromotive force Eₛ per unit length in the metallic shield layer satisfies the following relationship:

$${E}_{s} = 2 ω I ln \frac{2 s}{{D}_{s}} \times 1 {0}^{- 7} ( V / m )$$

When two ends of the metallic shield layer are grounded and the grounding resistance is sufficiently low, the current Iₛ in the metallic shield layer satisfies the following relationship:

$${I}_{s} = \frac{{E}_{s}}{{R}_{s} + jX}$$

Rₛ is a resistance per unit length of the metallic shield layer (Ω/m); X is a reactance per unit length of the metallic shield layer (Ω/m); and R is an AC resistance per unit length of the cable conductor (Ω/m).

For metallic shield losses of the cable per unit length Wₛ, the following relationship holds:

$${W}_{s} = {I}_{s}^{2} {R}_{s} = \frac{{I}^{2} {X}^{2}}{{R}_{s}^{2} + {X}^{2}} \times {R}_{s}$$

$${λ}_{1}^{′}$$

satisfies the following relationship:

$${λ}_{1}^{′} = \frac{{W}_{s}}{{W}_{c}} = \frac{{R}_{s}}{R} \times \frac{{X}^{2}}{{R}_{s}^{2} + {X}^{2}}$$

When three single-core cable conductors are arranged in a triangular formation, a circulating current loss factor of the metallic shield layer satisfies the following relationships:

$${λ}_{1}^{′} = \frac{{R}_{s}}{R} \frac{1}{1 + {( \frac{{R}_{s}}{X} )}^{2}}$$

$${R}_{s} = \frac{{ρ}_{s}}{{A}_{s}} [ 1 + {α}_{s} ( {θ}_{s} - 20 ) ]$$

$$X = 2 \cdot 2 π f \cdot {10}^{- 7} ln ( \frac{2 s}{{D}_{s}} )$$

where Rₛ is a resistance per unit length of the metallic shield layer, in Ω/m; X is a reactance per unit length of the metallic shield layer, in Ω/m; R is an AC resistance of the conductor, in Ω/m; s is the center-to-center spacing between cable conductors, in mm; Dₛ is an average diameter of the metallic shield layer, in mm; ρₛ is a resistivity of the material used for the metallic shield layer, in Ω·m; Δₛ is a cross-sectional area of the metallic shield layer, in m²; and θₛ is a temperature of the metallic shield layer, typically equivalent to 70%-80% of the conductor's operating temperature.

For the condition where a metallic shield layer is applied to a surface of each conductor's insulation layer,

$${λ}_{1}^{′}$$

satisfies the following relationship:

$${λ}_{1}^{′} = \frac{{R}_{s}}{R} \frac{1.7}{1 + {( \frac{{R}_{s}}{X} )}^{2}}$$

Under this condition, the eddy current losses in the metallic shield layer are negligible

$$( i . e . , {λ}_{1}^{″} = 0 ) ,$$

and

$$λ = {λ}_{1}^{′}$$

at this time. In the cable structure of this embodiment, the metallic shield layer is applied to the surface of each conductor's insulation layer.

For a loss factor λ₂ of the armor layer, it is the sum of a hysteresis loss

$${λ}_{2}^{′}$$

and an eddy current loss

$${λ}_{2}^{″}$$

of the armor layer, satisfying the following relationships:

$${λ}_{2} = {λ}_{2}^{′} + {λ}_{2}^{″}$$

$${λ}_{2}^{′} = \frac{{s}^{2} {K}^{2} \times 1 {0}^{- 7}}{{RD}_{a} δ}$$

$${λ}_{2}^{″} = \frac{2.25 {s}^{2} K δ \times 1 {0}^{- 8}}{{RD}_{a}}$$

$${λ}_{2} = \frac{{s}^{2} {K}^{2} \times 1 {0}^{- 7}}{{RD}_{a} δ} + \frac{2.25 {s}^{2} K δ \times 1 {0}^{- 8}}{{RD}_{a}}$$

$$K = \frac{1}{( 1 + \frac{{D}_{a}}{μ δ} )}$$

where s is the center-to-center spacing between adjacent cable conductors, in mm; δ is an equivalent thickness of the armor layer, in mm; Dₐ is an average diameter of the armor layer, in mm; and μ is a relative permeability of the armor layer, typically taken as 300.

In this embodiment, after providing the temperature sensing strategy, a final result can be obtained through matrix laboratory (MATLAB) computations, and Newton's iterative method may be employed to calculate the final result. After substituting the corresponding expressions of W_{c}, T₄, λ₁, and λ₂ as functions of the variable θ_{c}, the ambient temperature of 22° C. is set as an initial value in the program, with an error tolerance of 10⁻⁶. Iterations continue until the error falls within this tolerance range, yielding the final result.

In this embodiment, writing the unique identifier into the RF chip and uploading the identifier for storage when configuring the issuance information on the RF chip through the manufacturing module may include the steps that:
the tag encoding of the electronic tag is validated, and the electronic tag parameters and reader parameters stored in the RF chip are verified against the unique identifier; and
the unique identifier that has passed validation of the tag encoding, the electronic tag parameters, and the reader parameters are written into the RF chip and uploaded for storage.

The reader parameters include reader power and frequency, and the electronic tag parameters include data length and key type of the electronic tag.

In this embodiment, the electronic tag employs ultra-high-frequency (UHF) RFID chip technology. This chip technology breaks through the efficiency limitations of traditional rectifier circuits, achieving a highly efficient self-biasing rectifier that satisfies long-range reading requirements for the tag chip. It incorporates high-reliability data read/write circuitry technology to achieve highly reliable memory operation, meeting the demands for robust performance of the tag chip within normal application temperatures (<40° C.).

Using this electronic tag, coding and identification management during the production and manufacturing processes of cable equipment can be achieved. The electronic tag meets performance requirements for being metal-resistant, heat-resistant, and damage-resistant. By completing the segment coding of cable equipment at fixed intervals prior to cable delivery, and applying RFID IoT tags in accordance with a “self-coding/labeling for existing assets+supplier coding/labeling for incremental assets” model, front-end suppliers mount electronic tags on incremental assets, achieving batch, efficient, and rapid tag read/write operations. Through the association between the physical “ID” and the sub-labels of equipment components, the management of equipment transitions from batch-level to individual-unit-level, and further extends to granular traceability at the component level, enhancing the leanization and refinement of material management. By reading the electronic tag on cable reels, various types of information such as cable manufacturer, model, length, equipment order, and serial number can be obtained, which can coordinate identification code requirements from various stakeholders including manufacturing units, material management departments, and field maintenance personnel, addressing critical operational challenges in cable material management such as product substitution, false reporting of usage quantities, and residual material inventory inaccuracies. Consequently, it significantly enhances the accuracy of equipment monitoring and contract performance tracking, thereby ensuring a stable and orderly supply of power grid materials.

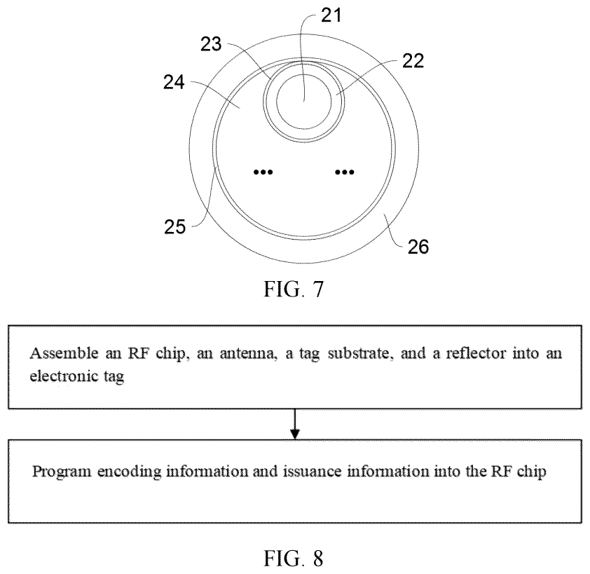

Referring to FIG. 8, the present disclosure provides a manufacturing method for an implantable RFID electronic tag for temperature measurement, adopting the above implantable RFID electronic tag system for temperature measurement, including the steps that:
an RF chip, an antenna, a tag substrate, and a reflector are assembled into an electronic tag; and
encoding information and issuance information are programmed into the RF chip.

Although the preferred embodiments of the present disclosure have been described, those skilled in the art, upon learning of the essential inventive concept, may make additional modifications and variations to these embodiments. Therefore, the appended claims are intended to be interpreted as covering the preferred embodiments as well as all modifications and variations that fall within the scope of the present disclosure. Obviously, for those skilled in the art, without departing from the spirit and scope of the present disclosure, a number of improvements and modifications can be made. Thus, if these improvements and modifications of the present disclosure belong to the scope of the claims and equivalents thereof, the present disclosure is also intended to include such improvements and modifications.

1. An implantable radio frequency identification (RFID) electronic tag system for temperature measurement, comprising an electronic tag, the electronic tag comprising a radio frequency (RF) chip, an antenna, a tag substrate, and a reflector;
the antenna and the reflector being located on upper and lower surfaces of the tag substrate, respectively; the tag substrate having a through hole, and the RF chip and the antenna being arranged inside the through hole; the RF chip being electrically connected to the antenna, and configured to detect temperature and incorporate a pre-programmed tag encoding; the antenna being formed by folding a metal sheet into a hollow box-shaped structure; the box-shaped structure comprising an upper sheet and a lower sheet, and a mounting pad being arranged inside the box-shaped structure to secure the RF chip; and the RF chip being electrically connected to one side of the lower sheet through an impedance matching tuning loop, with the other side of the lower sheet being connected to the upper sheet;
the tag encoding containing implantation information of the electronic tag and production information of a cable; the implantation information comprising serial information, and the production information comprising manufacturer information, batch information, and cable serial number information; the tag encoding further comprising data fields for cable type information, cable model information, and cable voltage level information; the serial information being associated with an implantation interval of the electronic tags; and adjacent electronic tags being implanted into the cable at predetermined intervals, with serial information data of the adjacent electronic tags encoded as consecutive numerical values;
the system further comprising a manufacturing module electrically connected to the electronic tag, the manufacturing module being configured to program encoding information and issuance information into the RF chip; the encoding information comprising the tag encoding; and the issuance information comprising a unique identifier and a temperature sensing strategy for detecting an internal temperature of the cable; and
the manufacturing module being configured to program encoding information and issuance information into the RF chip comprises the steps of:
generating the tag encoding based on the implantation information of the electronic tag and the production information of the cable, and writing the tag encoding into the RF chip;
providing the temperature sensing strategy based on cable parameters at an implantation position of the electronic tag and detected temperature parameters, combined with ambient temperature parameters of the cable's position;
generating the unique identifier based on electronic tag parameters and parameters of a reader matching the electronic tag, validating the tag encoding of the electronic tag, and verifying the electronic tag parameters and reader parameters stored in the RF chip against the unique identifier; and
writing the unique identifier that has passed validation of the tag encoding, the electronic tag parameters, and the reader parameters into the RF chip and uploading the identifier for storage, wherein the reader parameters comprise reader power and frequency, and the electronic tag parameters comprise data length and key type of the electronic tag.

2. The implantable RFID electronic tag system for temperature measurement according to claim 1, wherein the antenna comprises a rectangular metal patch, a ground plane, a shorting metal plate, a feed line, and a dielectric substrate; the ground plane is fixed to one side of the dielectric substrate, and the rectangular metal patch and the shorting metal plate are fixed to the other side; and the feed line is connected to the shorting metal plate, and two ends of the shorting metal plate are connected to the rectangular metal patch and the ground plane, respectively.

3. The implantable RFID electronic tag system for temperature measurement according to claim 1, wherein the RF chip comprises a temperature sensor circuit for temperature detection; the temperature sensor circuit comprises an analog front-end (AFE) circuit and an analog-to-digital converter (ADC) circuit connected to the AFE circuit; and the AFE circuit is configured to output a voltage and a voltage difference to the ADC circuit using two transistors with different bias currents, and the ADC circuit is configured to determine the detected temperature result based on the voltage and the voltage difference.

4. The implantable RFID electronic tag system for temperature measurement according to claim 1, wherein the tag encoding is specifically represented as:
$$TE = [ ( mi , to , mo , vl , bi , cr , si , cc ) \vert mi ∈ M , to ∈ T , mo ∈ O , vl ∈ V , bi ∈ B , cr ∈ CR , si ∈ S ]$$
$$mi = {\sum }_{j = 1}^{k} {D}_{j} ( d ) * {10}^{j - 1}$$
where TE is a dataset of the tag encoding, T is a data encoding subset for cable type information, O is a data encoding subset for cable model information, V is a data encoding subset for cable voltage level information, M is a data encoding subset for manufacturer information, B is a data encoding subset for batch information, CR is a data encoding subset for cable serial number information, and S is a data encoding subset for serial information; cc is a check code, mi is a data field for manufacturer information, to is a data field for cable type information, mo is a data field for cable model information, vl is a data field for cable voltage level information, bi is a data field for batch information, cr is a data field for cable serial number information, and si is a data field for serial information; and d is the manufacturer information, Dⱼ(d) is an American standard code for information interchange (ASCII) code corresponding to a jth symbol of the manufacturer information, and k is the number of symbols in the manufacturer information.

5. The implantable RFID electronic tag system for temperature measurement according to claim 1, wherein the cable comprises, from interior to exterior, a plurality of cable conductors, an insulation layer, a metallic shield layer, a filling layer, an armor layer, and an outer sheath, and the electronic tag is implanted between the armor layer and the outer sheath; and
the temperature sensing strategy satisfies the following relationship:
$${θ}_{c} = {θ}_{0} - 2 {θ}_{p} + ( {W}_{c} + 0.5 {W}_{d} ) {A}_{1} {T}_{1} - 3 [ {W}_{d} + ( 1 + {λ}_{1} ) {W}_{c} ] {A}_{2} {T}_{2} + 3 [ {W}_{d} + ( 1 + {λ}_{1} + {λ}_{2} ) {W}_{c} ] ( {A}_{3} {T}_{3} + {A}_{4} {T}_{4} )$$
where θ_{c} is a cable conductor temperature, θ₀ is an ambient temperature at the cable's position, θₚ is a temperature detected by the electronic tag, W_{c} is a cable conductor loss, W_{d} is a dielectric loss of the insulation layer, T₁ is a thermal resistance of the insulation layer, T₂ is a thermal resistance of the filling layer, T₃ is a thermal resistance of the outer sheath, T₄ is a thermal resistance of a surrounding medium, λ₁ is a resistive loss factor of the metallic shield layer, λ₂ is a resistive loss factor of the armor layer, and A₁, A₂, A₃, and A₄ are all correction coefficients.

6. A manufacturing method for an implantable RFID electronic tag for temperature measurement, adopting the implantable RFID electronic tag system for temperature measurement according to claim 1, comprising the steps of:
assembling an RF chip, an antenna, a tag substrate, and a reflector into an electronic tag; and
programming encoding information and issuance information into the RF chip.

7. A manufacturing method for an implantable RFID electronic tag for temperature measurement, adopting the implantable RFID electronic tag system for temperature measurement according to claim 2, comprising the steps of:
assembling an RF chip, an antenna, a tag substrate, and a reflector into an electronic tag; and
programming encoding information and issuance information into the RF chip.

8. A manufacturing method for an implantable RFID electronic tag for temperature measurement, adopting the implantable RFID electronic tag system for temperature measurement according to claim 3, comprising the steps of:
assembling an RF chip, an antenna, a tag substrate, and a reflector into an electronic tag; and
programming encoding information and issuance information into the RF chip.

9. A manufacturing method for an implantable RFID electronic tag for temperature measurement, adopting the implantable RFID electronic tag system for temperature measurement according to claim 4, comprising the steps of:
assembling an RF chip, an antenna, a tag substrate, and a reflector into an electronic tag; and
programming encoding information and issuance information into the RF chip.

10. A manufacturing method for an implantable RFID electronic tag for temperature measurement, adopting the implantable RFID electronic tag system for temperature measurement according to claim 5, comprising the steps of:
assembling an RF chip, an antenna, a tag substrate, and a reflector into an electronic tag; and
programming encoding information and issuance information into the RF chip.
